(19) United States
(12) Patent Application Publication
(10) Pub. No.: US 2009/0220197 A1
(43) Pub. Date: Sep. 3, 2009

(54) APPARATUS AND FIBER OPTIC CABLE RETENTION SYSTEM INCLUDING SAME

(76) Inventors: Jeffrey Gniadek, Northbridge, MA (US); Tomoyuki Mamiya, San Diego, CA (US); Stephen O'Riorden, Stow, MA (US); David Geldart, Arlington, MA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 12/421,278

(22) Filed: Apr. 9, 2009

Related U.S. Application Data
(63) Continuation-in-part of application No. 12/035,573, filed on Feb. 22, 2008.

(51) Int. Cl. G02B 6/38

(52) U.S. Cl. 385/62

(57) ABSTRACT

An apparatus includes a body member that defines a passageway which is configured to receive a rugged fiber optic cable at a first end of the passageway and a fiber optic connector at a second end of the passageway, a first arm member connected to the body member, and a second arm member connected to the body member and coplanar with the first arm member. The first and second arm members are configured to receive the fiber optic connector therebetween.

### RELATED APPLICATIONS AND CLAIM OF PRIORITY

This application is a continuation-in-part of U.S. patent application Ser. No. 12/035,573, entitled, “Apparatus and Fiber Optic Cable Retention System Including Same,” which was filed on Feb. 22, 2008, and which is hereby incorporated by reference in its entirety.

### BACKGROUND

This application discloses an invention that is related, generally and in various embodiments, to an apparatus for use with a fiber optic retaining system.

Fiber optic cable systems provide a large bandwidth capacity for the transmission of voice and data. In order to extend such systems closer and closer to the premises of the end subscribers, more and more fiber optic connections are required. Such connections are typically made by highly skilled field personnel utilizing specialized tools and equipment.

A conventional way of making an optical connection at a subscriber premise is to plug an end of a run of fiber optic cable into a fiber optic receptacle located at the premise. In order to form a satisfactory connection configuration at the end of the run of fiber optic cable, field personnel generally utilize a two-part crimp housing and a crimp band. The two-part crimp ring is positioned around a connector assembly which typically includes a connector body, a ferrule, a ferrule holder, a spring and a spring push. The crimp band is then positioned around the two-part crimp ring to secure the position of the two-part crimp ring. Although the field process of utilizing the two-part crimp ring and the crimp band to form a satisfactory connection configuration for the end of the run of fiber optic cable provides an adequate result, the use of a two-part crimp ring adds to the overall cost and complexity of producing the proper connection configuration.

### SUMMARY

In one general respect, this application discloses an apparatus. The apparatus includes a body member that defines a passageway which is configured to receive a rugged fiber optic cable at a first end of the passageway and a fiber optic connector at a second end of the passageway, a first arm member connected to the body member and a second arm member connected to the body member and coplanar with the first arm member. The first and second arm members are configured to receive the fiber optic connector therebetween.

Aspects of the invention may include one or more of the following features. The body member, the first arm member, or the second arm member may comprise a thermoplastic. The body member, the first arm member and the second arm member can be integrally formed. The body member can include a first portion which defines a first portion of the passageway, wherein the first portion of the passageway is configured to receive the rugged fiber optic cable, and a groove along a first surface of the body member, wherein the groove is configured to receive a strength member of the rugged fiber optic cable. The body member can include a second portion connected to the first portion, wherein the second portion of the body member defines a second portion of the passageway. The body member can include a third portion connected to the second portion of the body member, wherein the third portion of the body member defines a third portion of the passageway, wherein the third portion of the passageway is configured to receive the fiber optic connector. The first, second and third portions of the body member can be integrally formed. The first and second arm members can be connected to the third portion of the body member. The body member can define a second groove along the first surface of the body member, wherein the second groove is configured to receive a second strength member of the rugged fiber optic cable. The first arm member can define a first hook portion at an end thereof and the second arm member can define a second hook portion at an end thereof. The first hook portion may extend toward the second hook portion. The first and second hook portions can be configured to cooperate to secure a position of the fiber optic connector.

In another general aspect, this application discloses a fiber optic cable retention system. The system comprises a fiber optic connector, an apparatus which surrounds a first portion of the fiber optic connector, and a crimp ring which surrounds a first portion of the apparatus. The apparatus includes a body member, wherein the body member defines a passageway which surrounds the first portion of the fiber optic connector and a groove along a first surface of the body member. The apparatus also includes a first arm member connected to the body member, and a second arm member connected to the body member and coplanar with the first arm member. At least one of the first and second arm members partially surround a second portion of the fiber optic connector.

### DESCRIPTION OF THE DRAWINGS

Various embodiments of the invention are described herein by way of example in conjunction with the following figures.

FIGS. 1A-1D illustrate various views of an apparatus according to various embodiments;

FIG. 2 illustrates an optical portion of a rugged fiber optic cable received by the apparatus 10 of FIG. 1A according to various embodiments;

FIG. 3 illustrates first and second strength members of a rugged fiber optic cable received by the apparatus of FIG. 1A according to various embodiments;

FIG. 4 illustrates various embodiments of a fiber optic cable retention system;

FIG. 5 illustrates the positioning of a crimp ring of the fiber optic cable retention system of FIG. 4 over a portion of the apparatus of FIG. 1A according to various embodiments;

FIGS. 6A-6E illustrate various views of an apparatus according to various embodiments;

FIG. 7 illustrates an optical portion of a rugged fiber optic cable received by the apparatus 100 of FIG. 6A according to various embodiments;

FIG. 8 illustrates first and second strength members of a rugged fiber optic cable received by the apparatus of FIG. 6A according to various embodiments;

FIG. 9 illustrates various embodiments of a fiber optic cable retention system; and

FIG. 10 illustrates the positioning of a crimp ring of the fiber optic cable retention system of FIG. 9 over a portion of the apparatus of FIG. 6A according to various embodiments.

### DETAILED DESCRIPTION

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

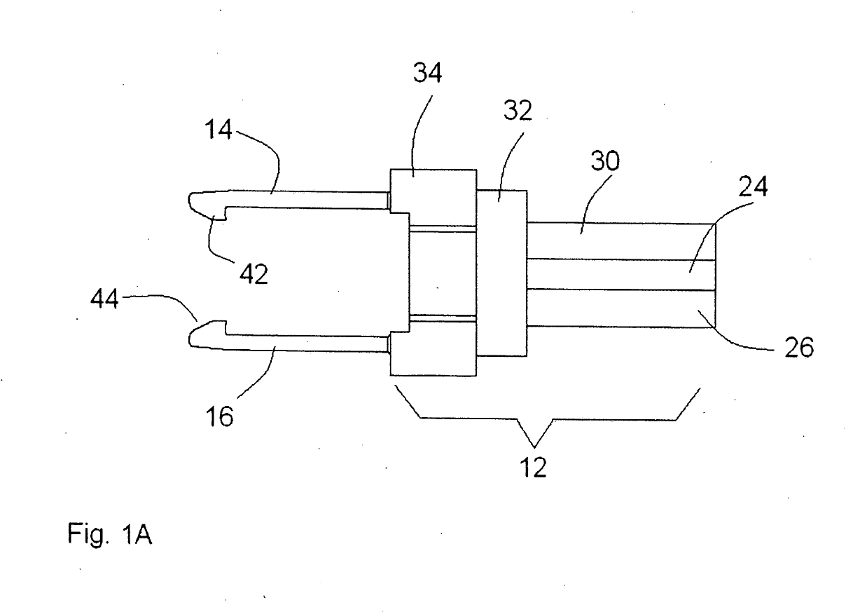

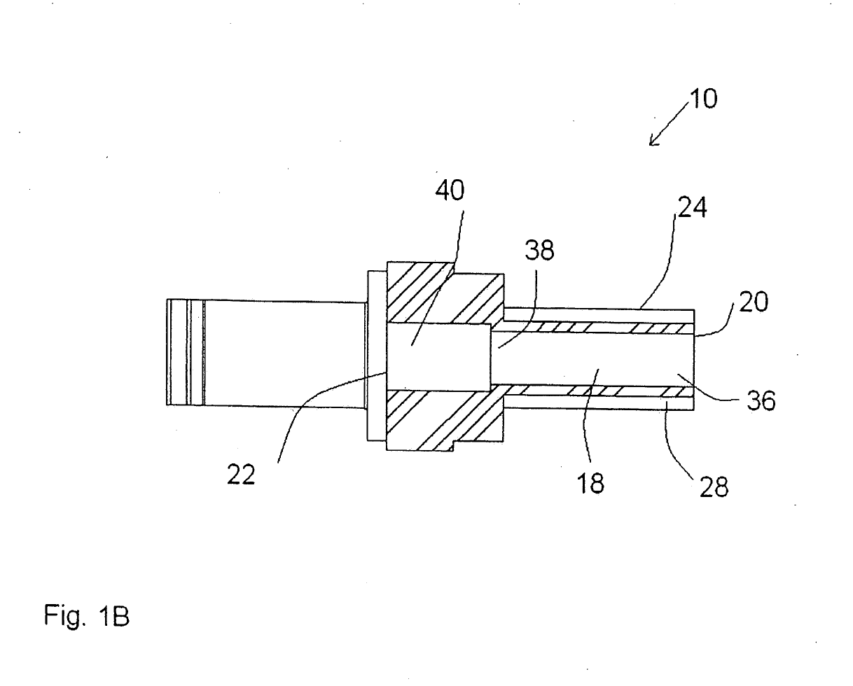

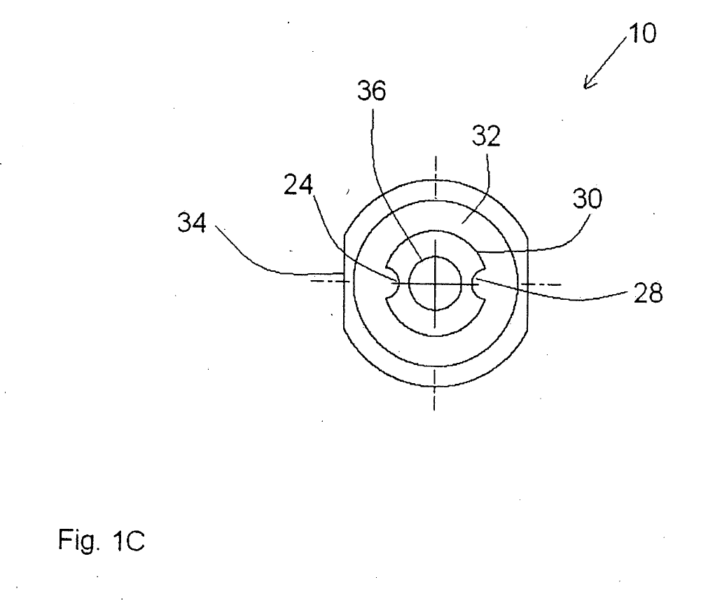

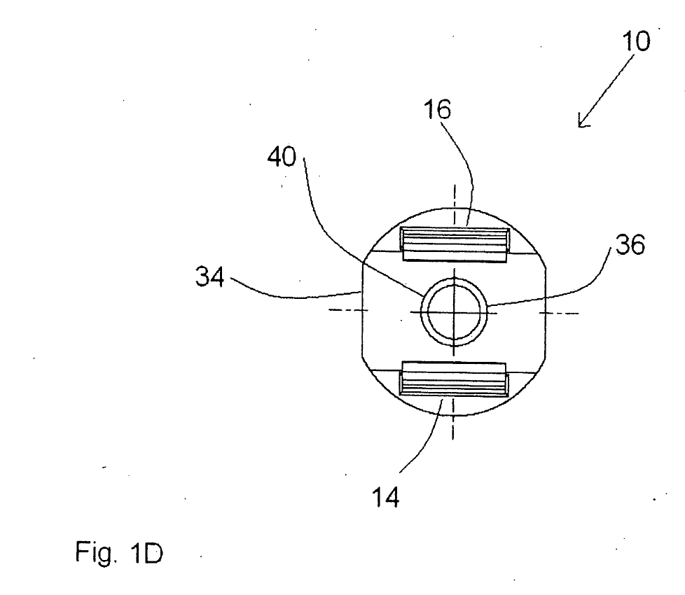

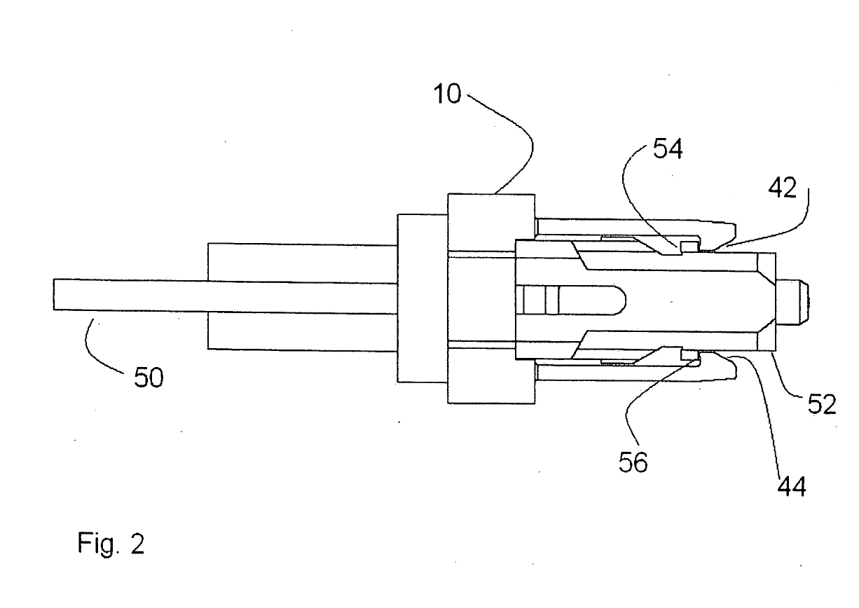

FIGS. 1A-1D illustrate various views an apparatus 10 according to various embodiments. The apparatus may comprise a portion of a fiber optic cable retention system as described in more detail hereinbelow with respect to FIG. 2.

As shown in FIG. 1A, which is a top view of the apparatus 10, the apparatus 10 includes a body member 12, a first arm member 14 connected to the body member 12, and a second arm member 16 connected to the body member 12. The apparatus 10 may be fabricated from any suitable material. For example, according to various embodiments, the body member 12 and/or at least one of the first and second arm members 14, 16 are fabricated from as plastic (e.g., a thermoplastic). The body member 12, the first arm member 14 and the second arm member 16 may be formed integral with one another.

As shown in FIG. 1B, which is a sectional view of the apparatus 10 taken along the line A-A of FIG. 1A, the body member 12 defines a passageway 18 which is configured to receive a rugged fiber optic cable at a first end 20 of the passageway 18 and a fiber optic connector at a second end 22 of the passageway 18. The body member 12 also defines a groove 24 along a first surface 26 (see FIG. 1A) of the body member 12. The groove 24 is configured to receive a strength member of the rugged fiber optic cable. According to various embodiments, the body member 12 may define a second groove 28 along the first surface 26 which is configured to receive another strength member of the rugged fiber optic cable. The second groove 28 may be configured the same as or similar to the groove 24. As shown in FIG. 1C, which is a rear view of the apparatus 10, the second groove 28 may be positioned opposite the first groove 24.

Returning to FIG. 1A, according to various embodiments, the body member 12 comprises a first portion 30, a second portion 32 connected to the first portion 30, and a third portion 34 connected to the second portion 32. The first, second and third portions 30, 32, 34 of the body member 12 may be formed integral with one another.

As shown in FIG. 1B, the first portion 30 of the body member 12 defines a first portion 36 of the passageway 18, and the first portion 36 of the passageway 18 is configured to receive the rugged fiber optic cable. The first portion 30 of the body member 12 also defines the groove 24, and according to various embodiments, also defines the second groove 28. The second portion 32 of the body member 12 defines a second portion 38 of the passageway 18. The third portion 34 of the body member 12 defines a third portion 40 of the passageway 18, and the third portion 40 of the passageway 18 is configured to receive the fiber optic connector.

Returning to FIG. 1A, the first and second arm members 14, 16 are connected to the third portion 34 of the body member 12, and are configured to receive the fiber optic connector therebetween. The first arm member 14 defines a first hook portion 42 at an end thereof. The second arm member 16 defines a second hook portion 44 at an end thereof. The first hook portion 42 extends toward the second hook portion 44. Thus, a distance between the first and second arm members 14, 16 is smallest between the first and second hook portions 42,44. The first and second hook portions 42,44 are positioned opposite one another and are configured to cooperate to secure a position of the fiber optic connector when the fiber optic connector is received between the first and second arm members 14, 16. By comparing FIG. 1C (which is a rear view of the apparatus 10) and FIG. 1D (which is a front view of the apparatus 10), it is apparent that the orientation of the first and second arm members 14, 16 is rotated approximately ninety degrees from the orientation of the first and second grooves 24, 28.

FIG. 2 illustrates an optical portion 50 of a rugged fiber optic cable received by the apparatus 10 of FIG. 1A according to various embodiments. The optical portion 50 is received in the first portion 36 of the passageway 18 of the apparatus 10. FIG. 2 also illustrates a fiber optic connector 52 positioned between the first and second arm members 14, 16. The fiber optic connector 52 may be any suitable type of connector (e.g., SC, LC, MT, ST, etc.), According to various embodiments, the fiber optic connector 52 may include a first tab 54 which cooperates with the first hook portion 42 of the first arm member 14 to secure the position of the fiber optic connector 52 with respect to the apparatus 10. The fiber optic connector 52 may also include a second tab 56 which cooperates with the second hook portion 44 of the second arm member 16 to secure the position of the fiber optic connector 52 with respect to the apparatus 10.

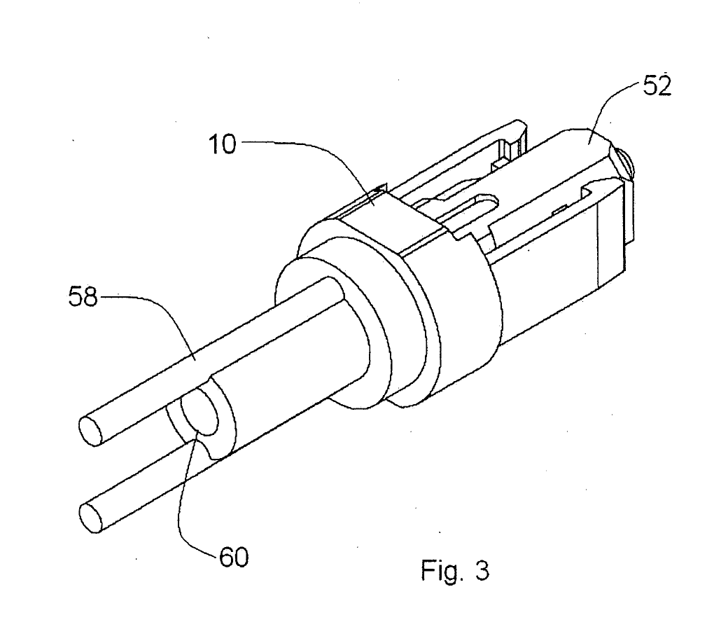

FIG. 3 illustrates various other portions (i.e., first and second strength members 58, 60) of a rugged fiber optic cable connected to the apparatus 10 of FIG. 1A according to various embodiments. As shown in FIG. 3, the first and second strength members 58, 60 of the rugged fiber optic cable are respectively seated in the first and second grooves 24, 28 of the apparatus 10.

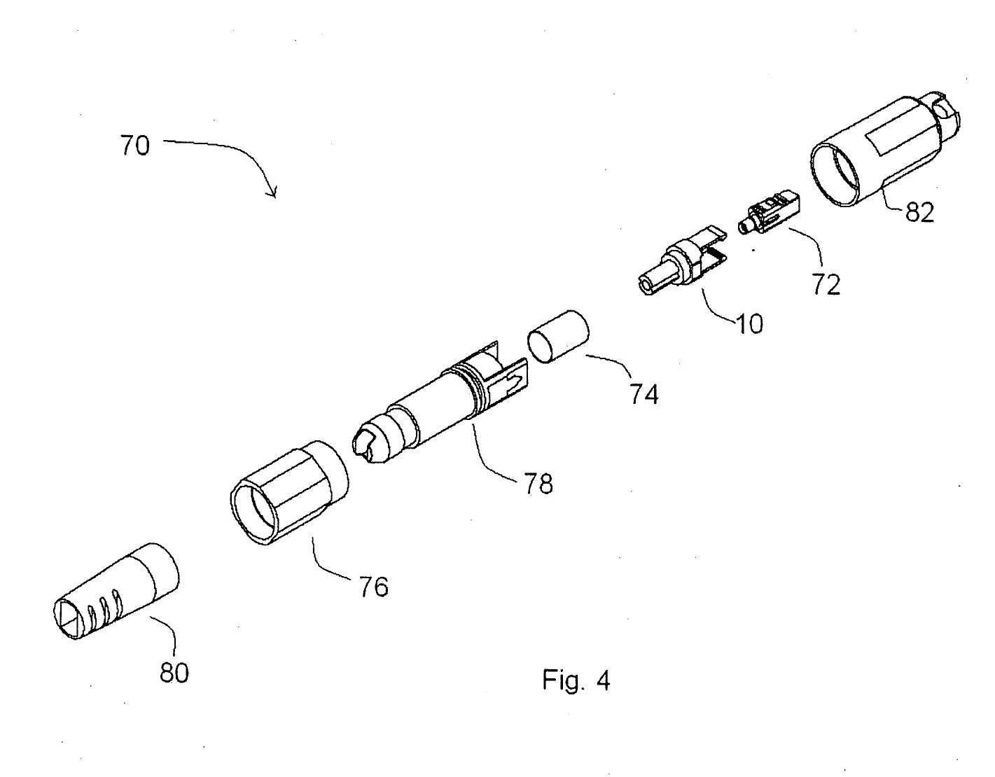

FIG. 4 illustrates an exploded view of a fiber optic cable retention system 70 according to various embodiments. The system 70 comprises the apparatus 10 of FIG. 1A, a fiber optic connector 72, and a crimp ring 74. The fiber optic connector 72 may be any suitable type of connector (e.g., SC, LC, MT, ST, etc.), and may be similar to or identical to the fiber optic connector 52. In addition to the apparatus 10, the fiber optic connector 72, and the crimp ring 74, the system 70 may also comprise a coupling nut 76 and a shroud 78. The system 70 may be utilized to configure a rugged fiber optic cable for connection to a receptacle. As shown in FIG. 4, the system 70 may further include a cable boot 80 and a protective cap 82.

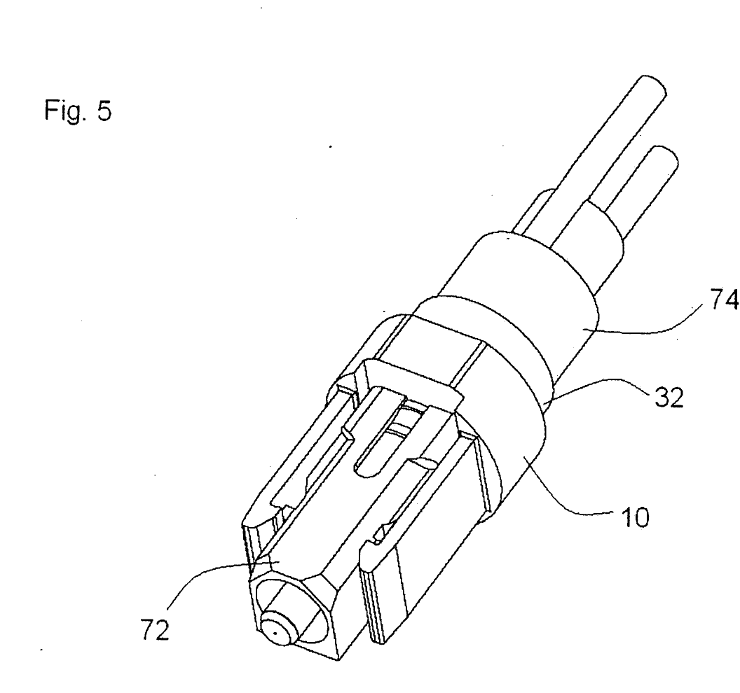

To utilize the system 70, according to various embodiments, a rugged fiber optic cable is first passed through the coupling nut 76, then through the shroud 78, then through the crimp ring 74. Once this has taken place, an optical portion of the rugged fiber optic cable is inserted into the first portion 36 of the passageway 18 of the body member 12 of the apparatus 10, and the first and second strength members 58, 60 of the rugged fiber optic cable are respectively seated in the first and second grooves 24, 28 of the first portion 30 of the body member 12. The first groove 24 partially surrounds the first strength member 58, and the second groove 28 partially surrounds the second strength member 60. The crimp ring 74 may then be positioned over the first and second strength members 58, 60 and the first portion 30 of the body member 12 to secure the position of the rugged fiber optic cable relative to the apparatus 10. FIG. 5 illustrates the positioning of the crimp ring 74 over the first and second strength members 58, 60 and the first portion 30 of the body member 12 according to various embodiments.

Either before, after, or concurrently with one or more of the above-described actions, the fiber optic connector 72 is passed between the first and second arm members 14, 16 of the apparatus 10 and is inserted into the third portion 40 of the passageway 18 of the body member 12. As described previously, first and second tabs of the fiber optic connector 72 may cooperate with the first and second hook portions 42, 44 of the first and second arm members 14, 16 to secure the position of the fiber optic connector 72 relative to the apparatus 10.

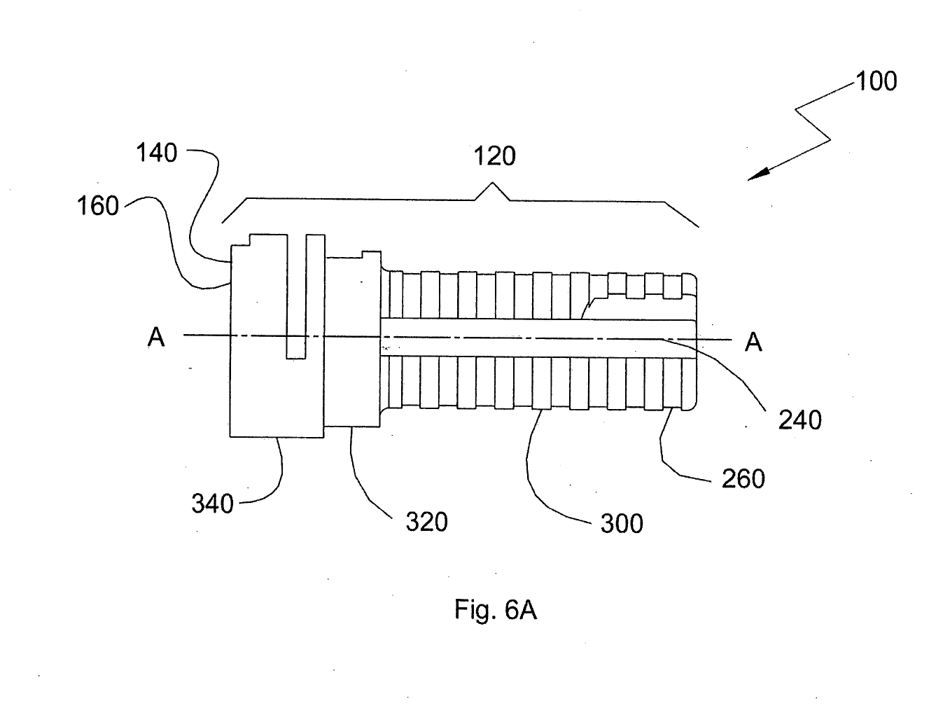

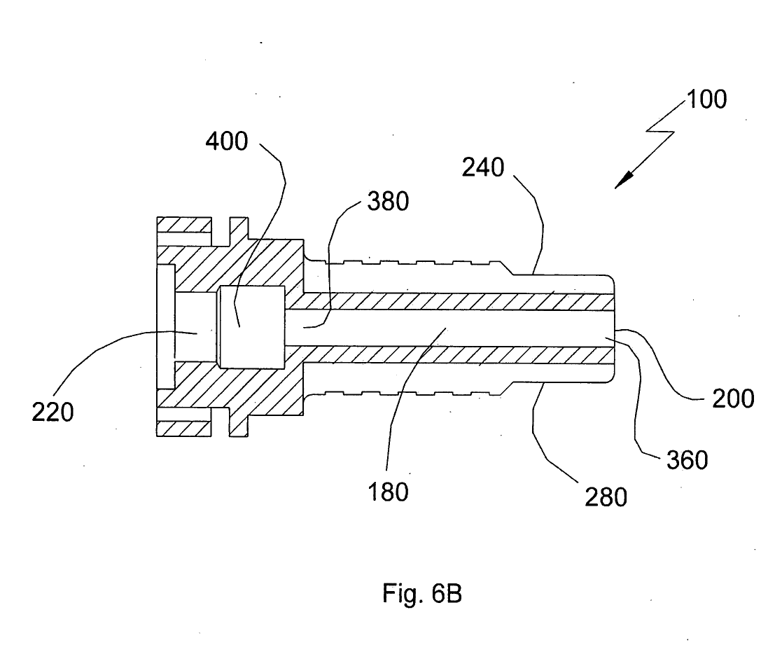

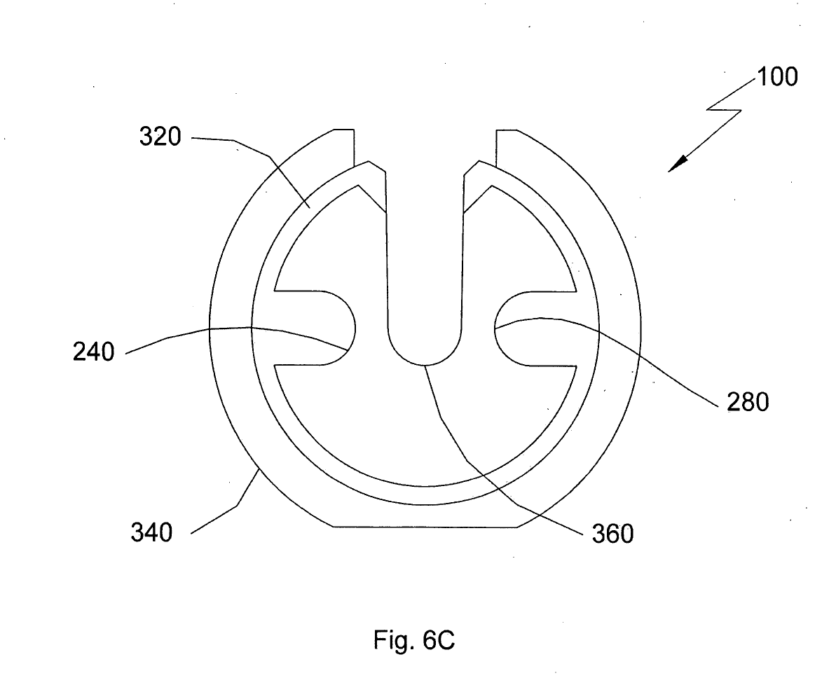

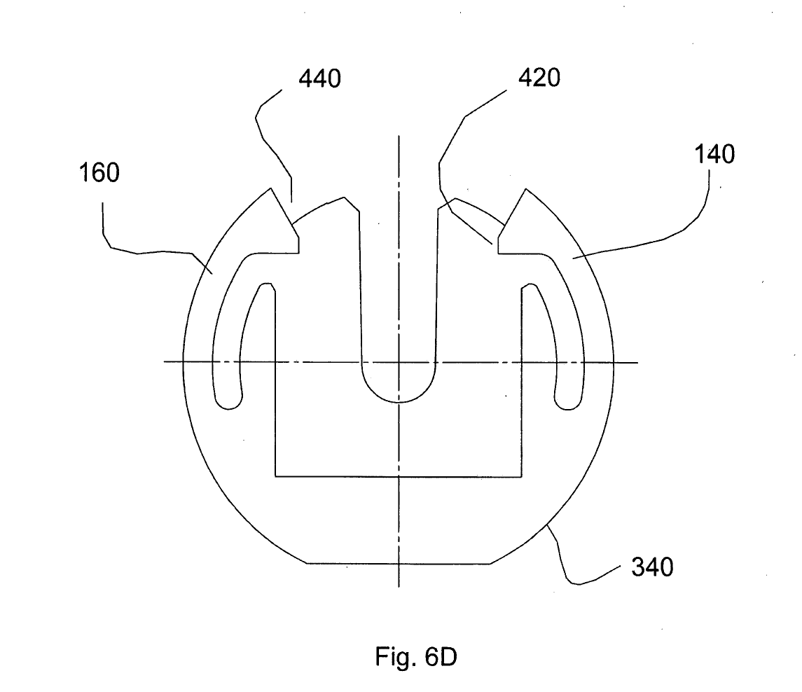

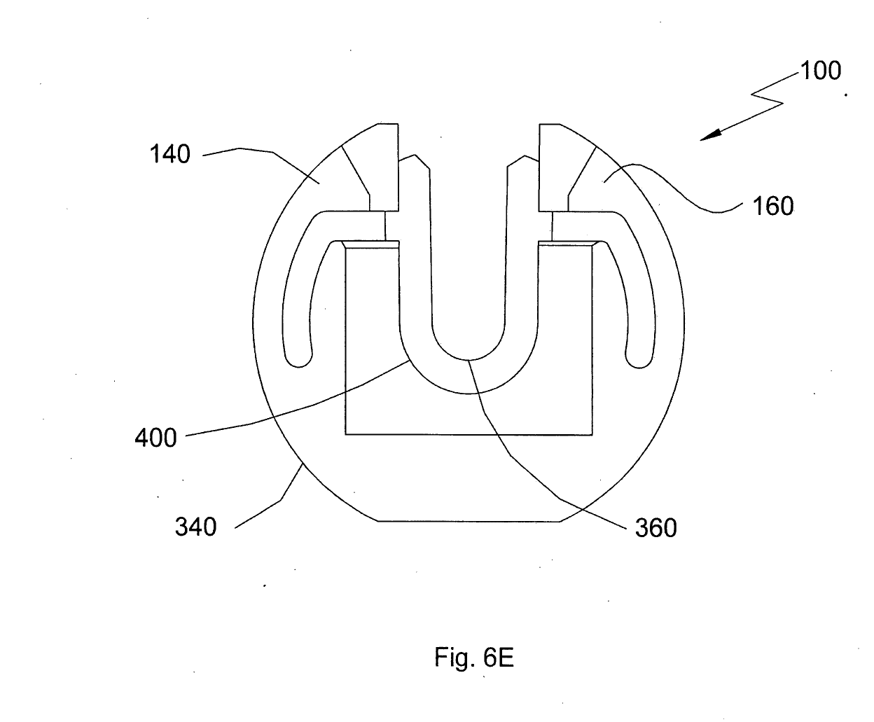

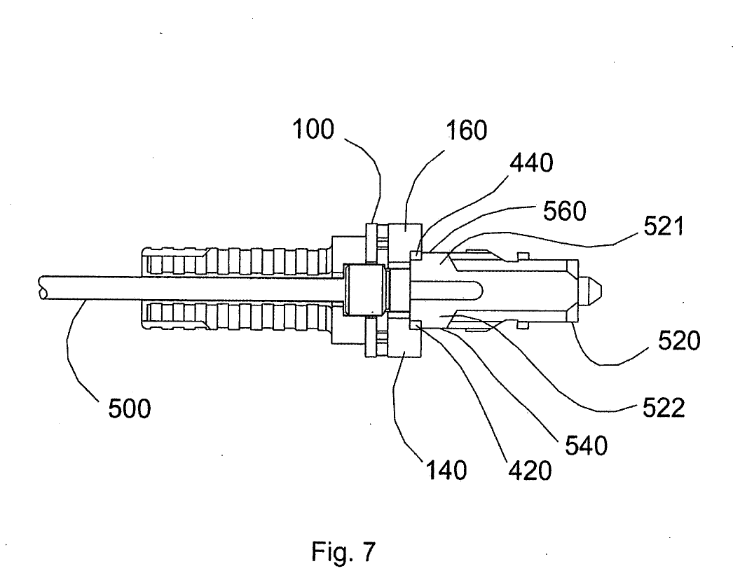

FIGS. 6A-6E illustrate alternative embodiments of the invention. The apparatus 100 may comprise a portion of a fiber optic cable retention system as described in more detail hereinbelow with respect to FIGS. 7-10.

As shown in FIG. 6A, which is a top view of the apparatus 100, the apparatus 100 includes a body member 120, a first arm member 140 connected to the body member 120, and a second arm member 160 connected to the body member 120. The apparatus 100 may be fabricated from any suitable material. For example, according to various embodiments, the body member 120 and/or at least one of the first and second arm members 140, 160 are fabricated from plastic (e.g., a thermoplastic). The body member 120, the first arm member 140 and the second arm member 160 may be formed integral with one another.

As shown in FIG. 6B, which is a sectional view of the apparatus 100 taken along the line A-A of FIG. 6A, the body member 120 defines a passageway 180 which is configured to receive a rugged fiber optic cable at a first end 200 of the passageway 180 and a fiber optic connector at a second end 220 of the passageway 180. The body member 120 also defines a groove 240 along a first surface 260 (see FIG. 6A) of the body member 120. The groove 240 is configured to receive a strength member of the rugged fiber optic cable. According to various embodiments, the body member 120 may define a second groove 280 along the first surface 260 which is configured to receive another strength member of the rugged fiber optic cable. The second groove 280 may be configured the same as or similar to the groove 240. As shown in FIG. 6C, which is a rear view of the apparatus 100, the second groove 280 may be positioned opposite the first groove 240.

Returning to FIG. 6A, according to various embodiments, the body member 120 comprises a first portion 300, a second portion 320 connected to the first portion 300, and a third portion 340 connected to the second portion 320. The first, second and third portions 300, 320, 340 of the body member 120 may be formed integral with one another.

As shown in FIG. 6B, the first portion 300 of the body member 120 defines a first portion 360 of the passageway 180, and the first portion 360 of the passageway 180 is configured to receive the rugged fiber optic cable. The first portion 300 of the body member 120 also defines the groove 240, and according to various embodiments, also defines the second groove 280. The second portion 320 of the body member 120 defines a second portion 380 of the passageway 180. The third portion 340 of the body member 120 defines a third portion 400 of the passageway 180, and the third portion 400 of the passageway 180 is configured to receive the fiber optic connector.

Returning to FIGS. 6A and 6D, the first and second arm members 140, 160 are connected to the third portion 340 of the body member 120, and are configured to receive the fiber optic connector therebetween. The first arm member 140 defines a first hook portion 420 at an end thereof. The second arm member 160 defines a second hook portion 440 at an end thereof. The first hook portion 420 extends toward the second hook portion 440. The first arm member 140 and the second arm member 160 are coplanar. The first hook portion 420 and the second hook portion 440 are also coplanar. Thus, a distance between the first and second arm members 140, 160 is smallest between the first and second hook portions 420, 440. The first and second hook portions 420, 440 are positioned opposite one another and are configured to cooperate to secure a position of the fiber optic connector when the fiber optic connector is received between the first and second arm members 140, 160.

Referring to FIG. 6E, the first portion 300 of the body member 120 defines a first portion 360 of the passageway 180. The first portion 360 of the passageway 180 is configured to receive the rugged fiber optic cable. The third portion 340 of the body member 120 defines a third portion 400 of the passageway 180. The third portion 400 of the passageway 180 is configured to receive the fiber optic connector.

FIG. 7 illustrates an optical portion 500 of a rugged fiber optic cable received by the apparatus 100 of FIG. 6A according to various embodiments. The optical portion 500 is received in the first portion 360 of the passageway 180 of the apparatus 100. FIG. 7 also illustrates a fiber optic connector 520 positioned between the first and second arm members 140, 160. The fiber optic connector 520 may be any suitable type of connector (e.g., SC, LC, MT, ST, etc.), According to various embodiments, the fiber optic connector 520 may include a first edge 540 which cooperates with the first hook portion 420 of the first arm member 140 to secure the position of the fiber optic connector 520 with respect to the apparatus 100. The fiber optic connector 520 may also include a second edge 560 which cooperates with the second hook portion 440 of the second arm member 160 to secure the position of the fiber optic connector 520 with respect to the apparatus 100. The connector 520 is assembled into the body member 120. The arm members 140, 160 bend outwardly to receive the connector 520. The connector 520 moves along the sloped hook surface of the hook portion 420 at the end of the arm member 140 and along the sloped hook surface of the hook portion 440 at the end of the arm member 160. The arm members 140, 160 return to the unbent position when the connector 520 is in the inserted position. The underside of the hook portions 420, 440 extend over the top edge 521, 522 of the connector 520. The hook portions 420, 440 act to lock the connector 520 into the passageway of the body 120.

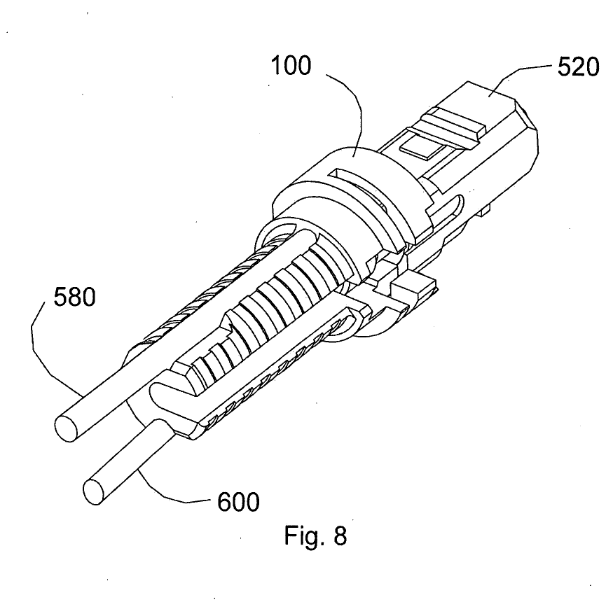

FIG. 8 illustrates various other portions (i.e., first and second strength members 580, 600) of a rugged fiber optic cable connected to the apparatus 100 of FIG. 6A according to various embodiments. As shown in FIG. 8, the first and second strength members 580, 600 of the rugged fiber optic cable are respectively seated in the first and second grooves 240, 280 of the apparatus 100.

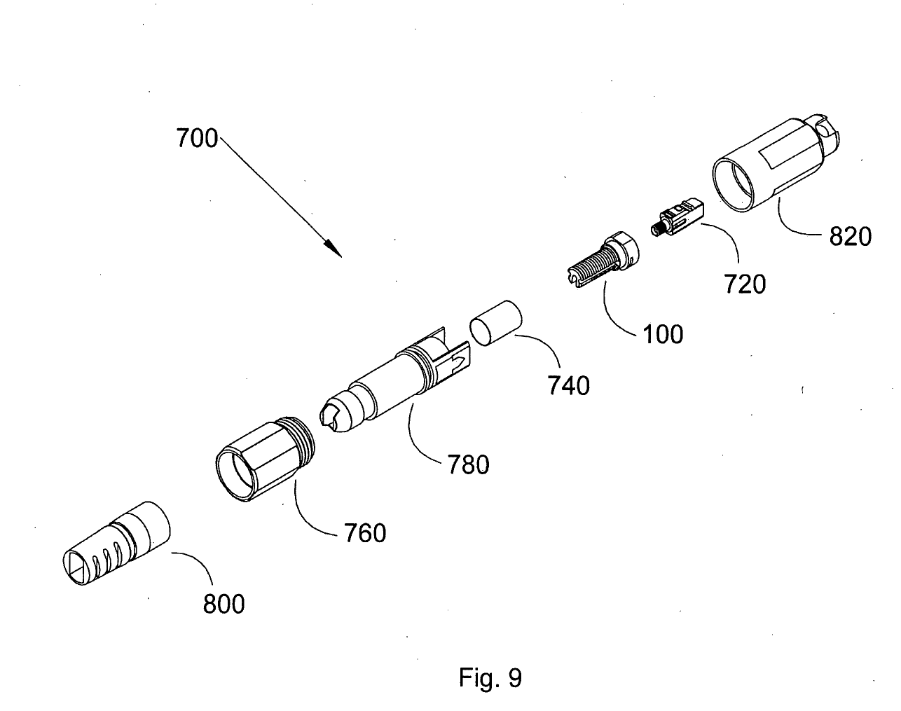

FIG. 9 illustrates an exploded view of a fiber optic cable retention system 700 according to various embodiments. The system 700 comprises the apparatus 100 of FIG. 6A, a fiber optic connector 720, and a crimp ring 740. The fiber optic connector 720 may be any suitable type of connector (e.g., SC, LC, MT, ST, etc.), and may be similar to or identical to the fiber optic connector 520. In addition to the apparatus 100, the fiber optic connector 720, and the crimp ring 740, the system 700 may also comprise a coupling nut 760 and a shroud 780. The system 700 may be utilized to configure a rugged fiber optic cable for connection to a receptacle. As shown in FIG. 9, the system 700 may further include a cable boot 800 and a protective cap 820.

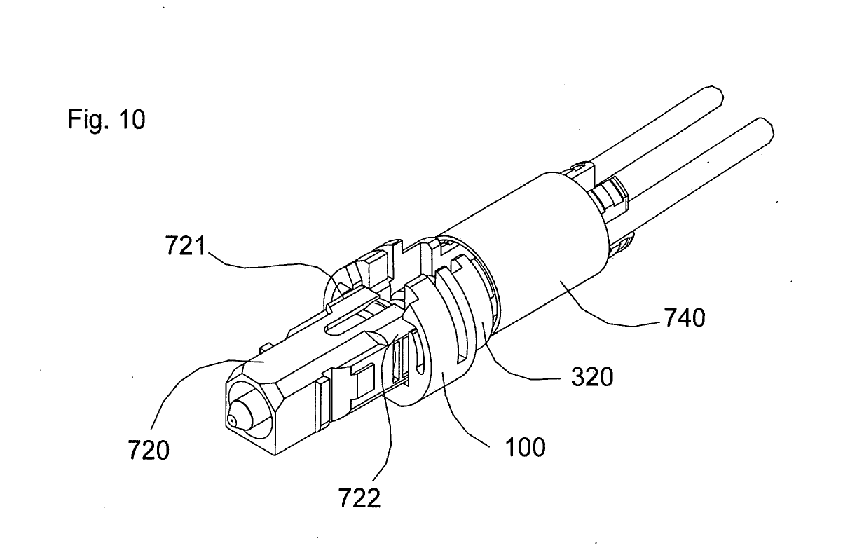

To utilize the system 700, according to various embodiments, a rugged fiber optic cable is first passed through the coupling nut 760, then through the shroud 780, then through the crimp ring 740. Once this has taken place, an optical portion of the rugged fiber optic cable is inserted into the first portion 360 of the passageway 180 of the body member 120 of the apparatus 100, and the first and second strength members 580, 600 of the rugged fiber optic cable are respectively seated in the first and second grooves 240, 280 of the first portion 300 of the body member 120. The first groove 240 partially surrounds the first strength member 580, and the second groove 280 partially surrounds the second strength member 600. The crimp ring 740 may then be positioned over the first and second strength members 580, 600 and the first portion 300 of the body member 120 to secure the position of the rugged fiber optic cable relative to the apparatus 100. FIG. 10 illustrates the positioning of the crimp ring 740 over the first and second strength members 580, 600 and the first portion 300 of the body member 120 according to various embodiments.

Either before, after, or concurrently with one or more of the above-described actions, the fiber optic connector 720 is passed between the first and second arm members 140, 160 of the apparatus 100 and is inserted into the third portion 400 of the passageway 180 of the body member 120. As described previously, first and second edges 721, 722 of the fiber optic connector 720 may cooperate with the first and second hook portions 420, 440 of the first and second arm members 140, 160 to secure the position of the fiber optic connector 720 relative to the apparatus 100.

While several embodiments of the invention have been described herein by way of example, those skilled in the art will appreciate that various modifications, alterations, and adaptations to the described embodiments may be realized without departing from the spirit and scope of the invention defined by the appended claims.

What is claimed is:

1. An apparatus, comprising:
a body member, wherein the body member defines:
a passageway which is configured to receive a rugged fiber optic cable at a first end of the passageway and a fiber optic connector at a second end of the passageway;
a first arm member connected to the body member; and
a second arm member connected to the body member and coplanar with the first arm member, wherein the first and second arm members are configured to receive the fiber optic connector therebetween.

2. The apparatus of claim 1, wherein at least one of the following comprise a thermoplastic:
the body member;
the first arm member; and
the second arm member.

3. The apparatus of claim 1, wherein the body member, the first arm member and the second arm member are integrally formed.

4. The apparatus of claim 1, wherein the body member comprises:
a first portion which defines:
a first portion of the passageway, wherein the first portion of the passageway is configured to receive the rugged fiber optic cable; and
a groove along a first surface of the body member, wherein the groove is configured to receive a strength member of the rugged fiber optic cable;
a second portion connected to the first portion, wherein the second portion of the body member defines a second portion of the passageway; and
a third portion connected to the second portion of the body member, wherein the third portion of the body member defines a third portion of the passageway, wherein the third portion of the passageway is configured to receive the fiber optic connector.

5. The apparatus of claim 4, wherein the first, second and third portions of the body member are integrally formed.

6. The apparatus of claim 4, wherein the first and second arm members are connected to the third portion of the body member.

7. The apparatus of claim 4, wherein the body member further defines a second groove along the first surface of the body member, wherein the second groove is configured to receive a second strength member of the rugged fiber optic cable.

8. The apparatus of claim 1, wherein:
the first arm member defines a first hook portion at an end thereof; and
the second arm member defines a second hook portion at an end thereof.

9. The apparatus of claim 8, wherein the first hook portion extends toward the second hook portion.

10. The apparatus of claim 8, wherein the first and second hook portions are configured to cooperate to secure a position of the fiber optic connector.

11. A fiber optic cable retention system, comprising:
a fiber optic connector,
an apparatus which surrounds a first portion of the fiber optic connector; and
a crimp ring which surrounds a first portion of the apparatus, wherein the apparatus comprises:
a body member, wherein the body member defines:
a passageway which surrounds the first portion of the fiber optic connector; and
a groove along a first surface of the body member;
a first arm member connected to the body member; and
a second arm member connected to the body member and coplanar with the first arm member, wherein at least one of the first and second arm members partially surround a second portion of the fiber optic connector.
